(19) United States
(12) Patent Application Publication
(10) Pub. No.: US 2006/0259789 A1
(43) Pub. Date: Nov. 16, 2006

(54) State maintenance

(75) Inventors: Jan-Erik Ekberg, Helsinki (FI); Nadarajah Asokan, Espoo (FI); Lauri Paatero, Helsinki (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/128,670

(22) Filed: May 13, 2005

(51) Int. Cl. G06F 12/14

(52) U.S. Cl. 713/194

(57) ABSTRACT

State information necessary to maintain securely is saved on a probabilistic basis onto a flash memory of protected memory chip. The protected memory chip has a communication logics that prevents access to the flash memory unless appropriate cryptographically protected instructions are given. By saving data on a probabilistic basis, the aging of the flash memory can be reduced so as to inhibit malicious destruction of the flash memory. The communication logics can also address different parts of the flash memory selectively so that any time the state information changes, something is written to the flash memory. To yet avoid premature aging of the whole flash memory, a dedicated disposable portion can be used for normal writing so that the remainder of the flash memory remains operable. Corresponding security circuitry, assembly module and computer programs are also described.

### FIELD OF THE INVENTION

This invention relates to state maintenance. It relates particularly, but not exclusively, to state maintenance on a portable device such as a mobile telephone.

### BACKGROUND OF THE INVENTION

Modem mobile telephones are becoming multipurpose devices capable of various new security applications such as banking and Digital Rights Management (DRM) clients. Such applications typically employ cryptographic measures for which non-volatile maintenance of state information is necessary. These applications are typically provided by digital integrated circuitry. A relatively small amount of state information can also be used to verify the integrity of a large amount of data stored onto a generally accessible storage that anyone or at least well-equipped attackers could tamper with. For instance, a cryptographic code can be computed based upon the whole of data of interest, stored securely and later verified again when the telephone is restarted. If a secure processor running such applications has a small amount of updatable space within its tamper-resistant persistent storage, it is easy to implement integrity protection for state information. Maheshwari et al. have disclosed such an arrangement in “How to Build a Trusted Database System on Untrusted Storage”, OSDI 2000. Unfortunately, having such updatable memory within the secure processor's tamper-resistant perimeter is expensive, especially on particularly resource constrained devices like mobile phones.

The economical reasons are eradicating the earlier common non-volatile rewriteable memories on digital integrated circuitries. Hence, the storing of state information and secure processing of applications cannot always be economically provided with a common integrated circuitry. Conversely, using a memory external to secure perimeter of the processing circuitry has been proposed. A co-pending patent application of the applicant, US2003007912, describes an external tamper-resistant security token which is used by the secure processor to integrity-protect its state storage. To make this work, the secure processor needs to be able to authenticate the external security token. US2003007912 discloses using a public key infrastructure for external security tokens. However, such a public key infrastructure is relatively complex to set up because it involves co-ordination and agreements between device manufacturers and manufacturers of external security tokens. It also imposes an amount of processing load onto the external security tokens or memories.

There are also device dependant security states which should be reliably accessible throughout the lifetime of the device. For instance, a mobile telephone may have a phone lock feature that effectively should prevent use of stolen phones. When the lock is engaged, an identifier of the present subscriber identity module (SIM) is stored in a rewriteable persistent memory of the phone with some representation (for instance, a one-way hash-code) of matching passcode. Whenever the SIM is replaced, if the phone protection is enabled, the phone first asks the user for the corresponding passcode and only if successfully entered, the phone stores the ID of the new SIM and allows its use. However, to prevent brute force attack, the phone must also maintain a counter of failed passcodes so that after three failed attempts, the phone becomes more thoroughly locked.

As is known in the art, the digital IC blocks tend to be cost optimised so that they cannot accommodate a rewriteable persistent memory (flash memory), as inclusion of such would mandate manufacturing 6 silicon layers instead of the common 4 for the whole of the area of the IC block. Hence, simply providing a secure processor with a non-volatile memory is not economically and technically suitable for all uses. On the other hand, it is known in the art that an analogue IC block can economically be adapted to contain a flash memory, but such flash memories can only be rewritten for a limited number of times dependent on the structure of the IC, materials used and the manufacturing processes. Further, analogue IC blocks are ill-suited for implementing secure processors otherwise required for running and controlling applications.

### SUMMARY OF THE INVENTION

It is an objective of the invention to avoid or at least mitigate the problems found in prior art.

According to a first aspect of the invention there is provided a security circuitry for storing information into a protected memory circuitry that is capable of reliably saving data for an estimated number of times, the security circuitry comprising:
a processor capable of negotiating with the protected memory circuitry an access to the protected memory circuitry and capable of producing state information desirable to maintain over power break-ups;
wherein the processor is configured to output information to the protected memory circuitry using the access probabilistically so as to guard the protected memory circuitry for securing reliable storing of information by the protected memory circuitry substantially as long as targeted.

Advantageously, the security circuitry according to the first aspect may extend the operability of a protected memory circuitry to any desired lifetime provided that the protected memory circuitry is capable of reliably storing information for the estimated number of times.

The processor may have access to a secondary memory and be capable of performing a plurality of security related operations and configured to verify a subsequent security related operation using a previously stored state information so that when a predetermined criterion is met, the processor uses the state information from the protected memory circuitry and when the predetermined criterion is not met, the processor uses the state information from the secondary memory.

The secondary memory may be selected from a group consisting of: a volatile memory of the security circuitry, an external volatile memory and an external persistent memory.

Based on the probabilistic outputting of information to the protected memory, the processor advantageously may use state information from the protected memory circuitry when the state information is reliably stored in the protected memory circuitry.

The protected memory circuitry may comprise a disposable portion for performing dummy state information storage and a use portion for substantially reliably saving the state information.

Advantageously to providing a disposable portion for dummy storage it can be made difficult or even impossible to detect whether the protected memory circuitry actually has been updated or not as storing information into the disposable portion may cause a power consumption peak similar to that when information is stored into the use portion. This makes attacking the security system more difficult.

The disposable portion may be used to store the state information with an error detection code. The processor may subsequently read the disposable portion and if the error detection code does not indicate errors, the processor can use the read state information. The security circuitry may be configured to send the state information to the disposable portion as long as no errors are indicated and only after the disposable portion no longer reliably stores information to send the state information to the use portion.

The access of the processor to the protected memory circuitry may be cryptographically protected. Such a protection may help to secure integrity of communications between the processor and the protected memory circuitry. The cryptographic protection may hinder eavesdropping and external detection of when information is actually output to the protected memory circuitry.

The security circuitry may have access to a non-volatile memory that stores authentication information for authenticating the security circuitry to a protected memory circuitry and the security circuitry may be further configured to use the authentication information for the encrypted access to the protected memory circuitry. The security circuitry may itself comprise the non-volatile memory that stores the authentication information.

The security circuitry may be configured to generate a cryptographic code based upon given information and the state information and to subsequently detect changes in the given information by using the state information obtained from the protected memory circuitry even if the given information has been changed whilst the security circuitry has been powered off.

According to a second aspect of the invention there is provided an assembly module comprising a security circuitry for storing information into a protected memory circuitry that is capable of reliably saving data for an estimated number of times, the security processor comprising:
a processor capable of negotiating with the protected memory circuitry an access to the protected memory circuitry and capable of producing state information desirable to maintain over power break-ups;
wherein the processor is configured to output information to the protected memory circuitry using the access probabilistically so as to guard the protected memory circuitry for securing reliable storing of information by the protected memory circuitry substantially as long as targeted.

The protected memory circuitry may further comprise a communication logics and a persistent memory. Advantageously, the communication logics may be configured capable to cryptographically authenticate and integrity protect information exchanged with the security circuitry. Further advantageously, the communication logics may be capable of detecting from encrypted information whether information should be stored into the dummy portion or into the use portion.

The protected memory circuitry may comprise an analogue integrated circuit comprising a flash memory. Advantageously, the protected memory circuitry may be integrated to an analogue integrated circuitry such as an energy management chip. Using two integrated circuits on a common assembly module is advantageous since then there is no need for these to communicate over an assembly module connector that is relatively easy to intercept. Moreover, using an analogue IC on the assembly module to provide a flash memory is very suitable for mass manufacture of mobile telephones, for instance. An analogue flash memory provision onto an EMC ASIC, for instance, may not require any extra silicon layers for the whole chip area and the probabilistic storage may overcome the limitations in rewrite numbers so that a good balance between safety and economics and material consumption is realised.

According to a third aspect of the invention there is provided a protected memory circuitry for providing probabilistic data storage for a security circuitry, comprising:
an analogue rewriteable persistent memory with at least two individually writeable portions including a use portion and a disposable portion;
a communication logics capable of cryptographically protected communications with the security circuitry, configured to receive cryptographically secured information and commands from the security circuitry and accordingly to store information into the use portion or to simulate storing into the use portion by storing information into the disposable portion.

Advantageously, the protected memory circuitry may be embedded onto a common assembly board with the security circuitry and cryptographically initialised to enable the cryptographically protected communications with the security circuitry.

Advantageously, the protected memory circuitry may be manufactured onto an energy management circuitry capable of managing power supply to one or more components with voltages beyond those economically manageable with digital circuitry. Advantageously, the analogue circuitry still necessary to run a modem mobile telephone can be doubled as a protected memory circuitry and integrated onto a common assembly module with the security circuitry so as to provide a relatively compact and safe construction and little or no extra cost in mass production.

According to a fourth aspect there is provided a computer program for controlling a processor to perform probabilistic saving of data, the computer program comprising:
computer executable program code for causing the processor to communicate with a protected memory circuitry capable of reliably saving data for an estimated number of times;
computer executable program code for causing the processor to negotiate with the protected memory circuitry an access to the protected memory circuitry;
computer executable program code for causing the processor to produce state information desirable to maintain over power break-ups;
computer executable program code for causing the processor to output information to the protected memory circuitry using the access probabilistically so as to guard the protected memory circuitry for securing reliable storing of information by the protected memory circuitry substantially as long as targeted.

According to a fifth aspect there is provided a computer program for controlling a communication logics of a protected memory circuitry further comprising a persistent memory capable of reliably saving data for an estimated number of times for providing a processor a substantially secure persistent storage, the computer program comprising:
computer executable program code for causing the communication logics to cryptographically communicate with the processor;
computer executable program code for causing the communication logics to receive cryptographically secured information and commands from the processor and accordingly to store information into the use portion or to simulate storing into the use portion by storing information into the disposable portion.

The computer program according to the fourth and/or fifth aspect of the present invention may be stored on a computer readable media. The computer program according to the fourth and/or fifth aspect of the present invention may be carried by an information signal.

Advantageously, the operation of the processor and/or the communication logics of the protected memory circuitry may be programmed by means of computer program written into a memory from which the program is subsequently executed to control the operation of a respective device. Advantageously, the program may be only written during production process of a device comprising the processor and the communications logics. Alternatively, the program may be stored on configuring a device comprising the processor and the communications logics for its normal use. The storing on configuration may be performed by service personnel or by an end user.

According to a sixth aspect of the present invention, there is provided a device comprising the security circuitry of the first aspect and the protected memory circuitry of the third aspect. The security circuitry and the protected memory circuitry may be integrated onto a common assembly module. The device may be a mobile device or a portable device or generally a resource restricted device for manufacture of which extreme cost saving may be important. The device may be selected from a group consisting of: a mobile telephone, a portable electric game, an electric book and an electric wallet.

Various embodiments of the present invention have been illustrated only with reference to the one aspect of the invention for sake of briefness, but it should be appreciated that corresponding embodiments may apply to other aspects as well.

### BRIEF DESCRIPTION OF THE DRAWINGS

The invention will now be described, by way of example only, with reference to the accompanying drawings, in which:

FIG. 1 presents a simplified block diagram of a mobile telephone assembly module according to a first embodiment of the invention;

FIG. 2 shows a basic flow chart illustrating external update decision making process employed by the secure IC 2 of FIG. 1; and

FIG. 3 shows a block diagram of a mobile telephone comprising the assembly of FIG. 1.

### DETAILED DESCRIPTION

The first embodiment is designed to enable a secure processor to securely store state information on an internal security token integrated onto a common assembly module. An internal security token is a part of the device. The security token need not be within the tamper-resistant perimeter of the secure processor. An example of a secure processor is a secure baseband ASIC chip on a mobile telephone or phone in short. A corresponding example of an internal security token is a separate Integrated Circuit (IC) chip (for instance, an energy management chip) on a common circuit board with the secure processor.

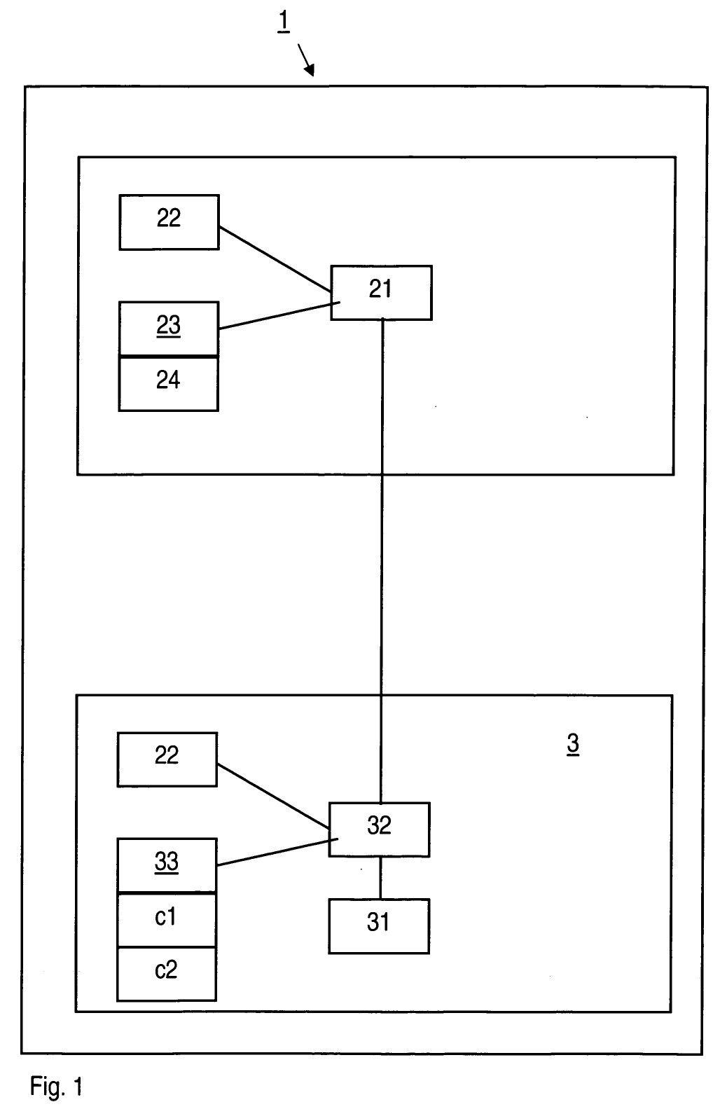

FIG. 1 presents a simplified block diagram of a mobile telephone assembly module 1 according to a first embodiment of the invention. The assembly module is a circuit board or other integral entity that carries two or more IC blocks. The IC blocks are referred, in the following, as IC chips regardless whether they actually contain any silicon chips.

The assembly 1 is depicted with two particular chips, a secure IC 2 and a supplementary memory providing block, an analogue Energy Management Chip (EMC) 3. The secure IC 2 is a Secure Baseband ASIC (SBA) which comprises a secure processor 21, a secure Random Access Memory 22 such as a Layer 1 cache and a non-volatile memory 23. The non-volatile memory 23 contains computer program code 24 for controlling the operation of the secure processor when loaded after start-up. The EMC 3 contains a processor 31, a logics circuitry 32 and a rewriteable non-volatile memory 33 such as an analogue flash memory. The EMC 3 advantageously provides normal analogue energy management functions, that is, controls the energy supply for components with a voltage higher than that controllable by digital circuitry of a typical cellular telephone. As an analogue chip, the EMC 3 can easily be adapted to provide one or more rewriteable non-volatile memory cells c1, c2 without additional silicon layers and associated cost. Such an analogue flash memory 33 is very economical to implement. Unlike analogue chips, digital chips typically would require two additional silicon layers to provide a flash memory for the whole of their area.

It should be appreciated that the invention is equally applicable with other types of IC blocks. In particular, the supplementary memory providing block need not be an EMC but any other external memory containing block is equally usable. A digital IC integrated in assembly 1 with a rewriteable persistent memory would be equally usable.

In order to fight against intentional exhausting out of the persistent memory, the SBA 2 and the EMC 3 are adapted to perform actual updates into the persistent memory probabilistically. The secure RAM 22 maintains the state information throughout the uptime of the phone and the non-volatile memory 33 is updated less frequently balancing the lifetime and security as will be described with more detail in the following.

The embodiments and features of the invention are next described with reference to the SBA 2 and to the EMC 3.

The SBA 2 can be any IC capable of running computer program code so that it is difficult to intervene to its execution when it runs applications in a so-called trust perimeter. The trust perimeter of the SBA 2 contains the necessary registers and memory areas generally that contain secured data. However, since the trust perimeter of the SBA lacks suitable persistent storage, the EMC 3 provides a trusted storage or token. The EMC 3 has a trust perimeter containing the logics circuitry 32 and relevant portions if not all of the rewriteable non-volatile or persistent memory 33. The logics circuitry 32 advantageously provides the only—and controlled—access to the relevant portions of the persistent memory 33. As is clear from the foregoing, not all of the persistent memory 33 has to be within secure perimeter of EMC 3, but for simplicity of description, in the following it assumed entirely secured.

The logics circuitry 32 of the EMC 3 is capable of secure communications with the SBA. The logics circuitry comprises particular important registers and numbers that are of particular value for the best mode of operation, such as a EMC specific identification key or keys and a linear counter if no true source of randomness is available. The keys and the counter or random code source are used for normal cryptological measures such as replay attack prevention. Further, the data of the EMC 3 enable the EMC 3 to only permit secure access to its persistent memory 33 so that ideally it should not be possible to simulate the SBA 2 and obtain access or exhaust the persistent memory 33.

The logics circuitry 32 of the EMC 3 need not be very intelligent. Instead, the SBA 2 can take care of integrity protection of the information stored into EMC 3. This helps to further simplify the EMC 3 and avoid generating undue costs.

The EMC 3 and the SBA 2 are typically initialised to work together as a secure pair when the telephone assembly module 1 is put together or when the device containing the assembly module 1 is put together. This phase is referred to as initialisation. The initialisation can also take place at a service point. The initialisation can be performed by storing necessary keys and also possibly authentication algorithm information to the EMC 3 and/or to the SBA 2. Further details of the initialisation and structure of the EMC 3 and the SBA 2 is provided in a co-pending patent application of the same inventors under title “IMPLEMENTATION OF AN INTEGRITY-PROTECTED SECURE STORAGE”. After initialisation, the SBA 2 and the EMC 3 are capable of communicating in a secure manner.

The probabilistic operation invented by the inventors can be roughly divided into two main categories:
1. Each decision to perform an external state update (that is, actually write data onto the EMC 3 memory 33) is independent of others. In this case, the system is memoryless in this regard.
2. Each decision can be based on a sliding scale which incorporates information about the frequency of past updates.

Main category 1 is simple to implement but has the vulnerability that an attacker can force many counter updates, thereby aging the integrity-protected persistent storage until it stops working and a free access may be obtained if not prevented by special means.

Main category 2 increases resistance against intentional aging of the memory 33 but requires that an attacker must not be able to determine when an update has actually been made. This requirement implies that all communication between the secure processor and the integrity-protected persistent storage must not be visible to the attacker. Integrating the SBA 2 and the EMC 3 to a common assembly module 1 largely helps in this regard by removing the need for interconnecting the SBA 2 and the EMC 3 by connectors potentially easy to intercept.

Regardless whether the main category 1 or 2 should be opted, several other safeguards can be taken to strengthen the system:
Application control: The privilege to change system state is restricted to trusted applications only so that an attacker cannot write his own application that attempts to force counter updates. This limitation can also include dynamic auditing or monitoring enforced by the system. Further, the trusted state changing applications could perform their own rate-limiting of state changes within a given time interval so as to inhibit intentional aging of the persistent memory 33 with ridiculously frequent updates. For instance, no normal user wants to change a DRM protected song that is played 20 times a second and thus impose hundreds of external updates in brief while. That situation is an indication of a malfunction or a persistent memory exhaustion attack.
Run-time integrity control. During system uptime, the secure processor can and should ascertain the integrity of its state against rollbacks by keeping integrity information in its non-persistent but secure memory. This safeguard should inhibit taking over the SBA 2 for malicious purposes.
Dummy counter update commands. In the case where the state update is not deterministic and the user can guess which state updates are not protected by external storage, the attacker can e.g. guess the wrong password, notice that the secure processor is going to update the state, disconnect the integrity-protected memory from the processor and reboot the device. To avoid this, also local (‘dummy’) state updates advantageously result in ‘update commands’ to the external storage whenever the state could potentially change. If the update were to be really carried out, a flag would be set to indicate this. All update commands are advantageously encrypted so that the attacker cannot determine whether or not a given update command triggers a real external update of a security state. Further fake or virtual updates advantageously even involve a WRITE operation to a fixed, ‘throw-away’ memory location or flash memory cell on the persistent memory 33. Such a location can safely fail relatively soon when that memory location ages, but the end result still produces an energy-consumption pattern similar to a real update. The relatively high current that occurs when updating a flash memory embedded onto an analogue IC causes a visible peak in power-consumption.

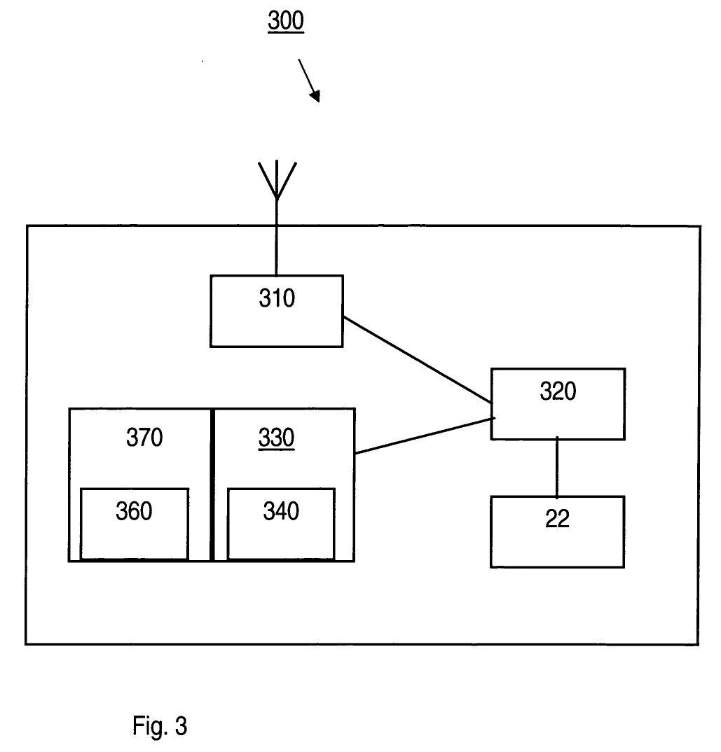

During system uptime, that is, whilst the SBA 2 sustains its normal operation, the SBA can and should ascertain the integrity and statefulness of the persistent memory 33 using the secure RAM 22. To verify the integrity, the SBA can be configured to make use of a long-lasting memory of its host device or accessible to its host device, such as the non-volatile application and user information memory 330 shown in FIG. 3. For instance, a mobile telephone typically contains some internal flash memory and/or banks or slots for receiving replaceable memory modules. Further, the host device may be connected to an external or internally installed hard disk or other memory unit. The long-lasting memory need not be secured as well as the persistent memory 33, but it can yet be used to maintain a copy of the state information maintained by the secure RAM or to maintain a derivative such as a Message Authentication Code (MAC) based on the state information and generally such a long-lasting memory 330 can normally be secured for the up-time of the host device.

The basis of a probabilistic determination of external security state updates to an external state-keeping component (ESC) or the persistent memory is next explained. Variable t denotes the number of seconds since most recent of the events: last ESC memory update and last phone boot. Conversely, an estimate for daily ESC memory update frequency y(t), if a new update were to be made after t seconds interval can be defined by the equation
y(t)=(86400/t) (1)

Hence, y(t) defines how many ESC memory updates per 24 h would be done if an ESC memory update should be done at this instant and furthermore always with the interval represented by present value of t. This and other real values can be scaled, by 1000, for instance, if calculations are made in integer arithmetic for simpler processing.

Based on y(t), a memory parameter (floating average) for the frequency of updates at a given time t can be constructed whenever a successful update is performed:
m₀=y(t₀) (2)
m(i+1)=[(p−1)/p]m(i)+(1/p)·y(t) (3)
where m₀ is m(0), that is, initial external update frequency estimation at initial moment t₀ and m is current accumulated frequency. Variable i is an integer index that grows from 0 and p is a constant defined in Equation (4).

Let us assume required lifetime of T years for the system, where T is a positive real number, and that the persistent memory EMC 3 has N individually usable flash cells each with a expected life of C updates at a desired probability such as 99,9%. The amount of allowable updates per day can be represented by a constant p according to equation (4):
p=(N·C)/(T·365) (4)

The external memory update decision—whether to perform a state update only in local memory by increasing a locally stored state or by actually updating ESC memory—can be based on the following rules, for example.

During boot and shutdown If a subcounter representing the number of updates made in local memory is bigger than a fixed value, then make an external update. Alternatively, if the time lapsed during boot up is long enough, such as more than 86400/p (seconds), the external update could be done on every boot. The subcounter can also be referred to as a substate. If not all security states or security state data are updated to EMC 3, the substate is the latest actual state. This latest actual state is stored during uptime in the secure RAM 22 (that is, in the internal memory of IC2), but not necessarily externally updated to EMC 3 due to the probabilistic update approach. Consequently, if the state version logged in EMC 3 is version_{EMC}, the substate version is as new or newer and hence the present state version version_{IC}>version_{EMC}. In case of frequent updates, version_{IC} may actually in some extreme cases be fairly much bigger than version_{EMC}. In a next boot-up, the update frequency is reset. Notice that if there were many state changes not updated to the EMC, there exists a window of opportunity for the attacker who could replace the information stored in the long-lasting memory 330 with its earlier contents. If, however, the version of the security state of the IC2 is older than the state in EMC, a system failure results, because this may happen if an attacker has tampered the long-lasting storage 330 over rebooting or restarting the device containing the sub-assembly 1.

If the difference between state versions on SBA and EMC 3 meets or exceeds the threshold value, the new state should be updated externally to EMC immediately, as no restrictions depending on y and m apply at (that is, there are stage probabilistically preventing from updating the EMC state).

When a state update is requested by an application the decision to make it external can be done in the following way: A random value r ⊂[0,1] is compared to a desired external update probability j (scaled to [0,1]) of the values stated below, and if r<j then make the update in ESC memory, otherwise do only a local update.

The state update can be simply a secure storage write or rewrite operation, generally referred to as memory updating. However, the applications that can access the persistent memory 33 are preferably capable of requesting for ‘dummy’ state updates. The secure applications can also advantageously indicate the importance of the state update in question to the SBA 2 so that the SBA 2 can make well-balanced decisions on true external updates. At least some of the following parameters are advantageously taken into account in deciding for a given update whether to perform an actual external update or not.

current subcounter value

current annual updating frequency y(t)

the ‘counters left’—value s=(N·C—current external counter value)

current accumulated frequency m

Note that even in the case where the update decision is negative (so that no external update of the state to the flash storage in the ESC is performed), normal ESC ‘protocol’ is advantageously carried out in full to make it hard for eavesdroppers to determine by external monitoring in which manner the state was updated. In this case, the signalling otherwise matches the normal but indicates somehow to the EMC 3 that a dummy update is requested. Such a virtual update should make it difficult to conclude whether an external update actually takes place or not as otherwise an attacker might notice the difference from simply the amount of signalling that occurs between the SBA 2 and the EMC 3.

Additional Considerations

1) Low- or No-priority state updates as commanded by applications may or may not trigger an actual state update (based on the decision parameters). The benefit of doing so is in the increased non-deterministic behaviour of the update system.

2) If applications are allowed to update the state in an unlimited fashion, there is a risk that an actual ‘external’ state update can be forced—leaving a subsequent high-probability window for free roll-backs the EMC memory can be methodically updated until the memory cells lose their storage capacity. Limiting state updates explicitly triggered by applications by time, for instance, can alleviate this risk. To implement this, the SBA 2 is advantageously equipped with a secure clock and means for identifying applications reliably. Error handling in the applications themselves can be employed to reduce the probability for malfunctions due to external stimulus such as a viral stimulus.

Applications requesting or triggering state updates can be uniquely identified by relying on a trusted operating system—bootstrapped with hardware boot authentication—to identify applications with cryptographic hashes calculated over the application or its binary representation in memory, for instance.

Auditing application behaviour in addition to the identification above provides history information based on which badly behaving applications may be denied state update rights. The history information advantageously contains some log that defines how often the application has caused events that normally would require an external update. This enables controlling applications so that they can be prevented from overloading the external memory. To do so, there are two main alternatives: external update requiring activities are altogether restricted so that the application cannot proceed with any activities which would call for an external update for a predefined and possibly adaptively growing interval following the last update to any memory. Second, the external update requiring activities may be allowed so that the external updates are made with a lowered likelihood so that the lifetime of the persistent memory 33 is not excessively shortened.

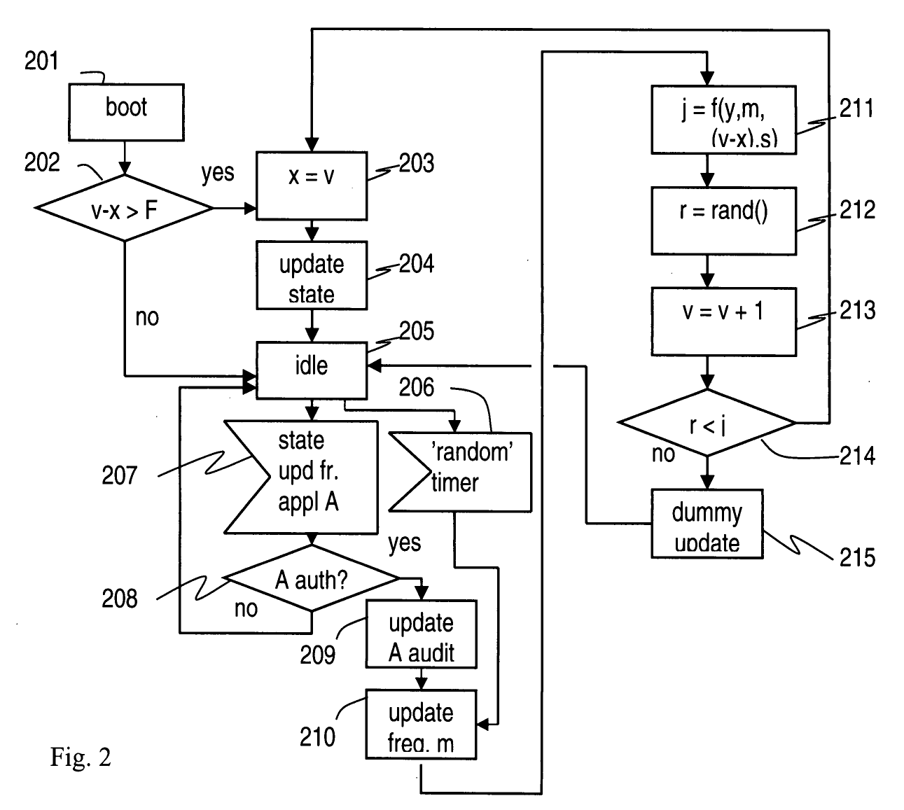

FIG. 2 shows a basic flow chart illustrating external update decision-making process employed by the SBA 2 of FIG. 1. The flow chart starts from booting up situation in which a mobile telephone equipped with the assembly module 1 started up at step 201. After boot up, it is checked 202 whether the state counter v on a long-lasting memory supposedly matching with the last state counter in the secure RAM 22 is more than predetermined amount F greater than the state counter x stored by the persistent memory 33. If not, the process jumps to step 205. If yes, an external update is made and the value of v is stored into x at step 203 and an external state update is made at step 204. After step 204 or step 202 if the respective determination is negative, the SBA 2 idles in step 205 until an event corresponding to step 206, random timer reaching a given value, or 207, an application A requesting an external state update, takes place. Step 207 is followed by step 208 wherein it is checked whether the application A passes authorisation. If no, the process resumes to idle at step 205, otherwise the process advances from step 208 to step 209 to update application A auditing data or history data using which the malicious behaviour of an application can be detected. After step 209, the current accumulated update frequency m is calculated in step 210. Next, the desired external update probability j is computed (211) as a function f of y, m, v, x and s, where s represents estimated remaining reliable external updates to the secure persistent memory 33. The function f is selected such that the desired lifetime of the persistent memory 33 is achieved and the external updates occur around a target interval, but not with even intervals but with sufficient unpredictability. It is advantageous for the function f to have the following properties:
The result is a number between 0 and 1 (the higher, the more suitable the present moment is for an update)
the values yielded by f sharply decrease as s approaches 0 to extend the last storage times
whilst m, (v-x) and 1/y are not independent, for high m values f should approach 0, and the relation for (v-x) can be weakly exponential and possibly multiplied by m.

Next, a random value between 0 and 1 is set to r at step 212, the counter v is incremented by 1 at step 213 and r is compared with j at step 214. If the value of r respective to the value of j warrants an external update, the process resumes to step 203, otherwise a dummy external update is performed at step 215 and the execution resumes to step 205. The decision made in step 214 is typically that of detecting whether r is greater than j or greater or equal than j. It is also clear to a person ordinarily skilled in the art that the comparison between r and j is intended to make a probability based decision and equivalently to the described manner, the value of j can be computed so that an external update is made if r is smaller or not greater than j. Moreover, the random values need not be computed between 0 and 1, inclusive. Instead, one or both of the end values can be excluded and the range can also be chosen between any real numbers as long as the value of j is so defined that the desired frequency of external updates results.

FIG. 3 shows a block diagram of a mobile telephone 300 comprising the assembly of FIG. 1. The mobile telephone 300 comprises the assembly module 1, a radio transceiver block 310, a Master Processing Unit (MPU) 320, a non-volatile application and user information memory 330 also containing operating instructions 340 for controlling the operation of the MPU 320, and a work memory 350. The non-volatile application and user information memory 330 contains an internal memory of 80 MB, for instance, and a memory card 360 accessible via a memory card slot 370.

Referring back to FIG. 1, it is recalled that the persistent memory 33 that stores state information advantageously contains at least two independently accessible memory cells or individual portions. The use of such different cells of the persistent memory 33 is next further described. Let us assume there are 16 different cells numbered as c0, c1, c2, . . . c15, each capable of storing 32 bits. Let us denote c0 as the disposable cell. Let us further assume that 20 bits are needed for state storage. This leaves 12 bits for error detection and possible error correction using methods known in the art, including convolution coding, cyclic redundancy codes and forward error correction codes. The number of bits required for the storage advantageously is selected such that the used number of different states is not less than the number of cells in use for storing information multiplied by the estimated reliable rewriting number of each. For instance, if 15 cells function as use portions each capable of saving 32 bits 6000 times, there are 15×6000 expectably reliable rewriting times usable (=900 000 times) and 20 bits yielding 1048575 new updates (above 0) should suffice. On the other hand, if only 3000 rewrites are expected, 19 bits should suffice and thus 13 bits could be used for useful redundancy. The data can be protected with redundant information either by the logics circuitry 32 of the EMC 3, by the SBA 2 and especially by the secure processor 21, or by both the logics circuitry 32 and the secure processor 21.

For securing an external long-lasting memory against tampering whilst the secure processor 21 is switched off, it suffices to maintain one counter as state information. The counter steps by constant integer of 1 and this known behaviour of the counter can additionally be employed as an error correction method. Assume that the 15 cells c1 to 15 contain values 146 to 150 and 136 to 145, respectively. The latest state information is stored in cell c5, with the highest value 140. If cell c5 was corrupted and indicated as such by the redundancy, it could still be extrapolated from the other cells that the correct value for c5 should be 150. Additionally, if cell c1 is given the first value 1, c2 value 2 . . . , it can be seen that a cell N should only have values with a remainder after integer division by 15 equal to its number.

If there two or more adjacent corrupted cells are found, say c5 and c6, and the preceding cell c4 holds the highest counter value or most recent state information, then it is impossible to say which one of the cells c4, c5 and c6 should have the present state information. In such a case, it should be presumed that c4 contains the last value and next c7 should be written, as it is apparent that c5 and c6 are no longer reliable. Consequentially, when corrupted cells are found, it no longer is possible to rely on the remainder rule. As an advantage, the use of error detection and subsequent neglecting of corresponding cells enables using remaining cells until none of the cells can store the information anymore. It is also very useful to test the writing operation immediately by reading all the cells and in case the written value is not maintained, it can be rewritten to another cell that the error detection does not indicate as corrupted. Such repeated writing operation can be detected as two power consumption peaks and thus an attacker might benefit from realising a possible opportunity to make free guesses without leaving trace into the persistent memory 33. This is a minor drawback, however, since there would be only N−1 such repeated writing operations, where N is the number of the cells, out of total number of rewritings during the whole life time of the persistent memory. That is, with 6000 rewrites per cell, once out of 6000 times would the attacker possibly notice exhaustion of a cell and possible window of opportunity to attack. This risk can further be reduced by making sporadic double writes using the disposable memory.

Particular implementations and embodiments of the invention have been described. It is clear to a person skilled in the art that the invention is not restricted to details of the embodiments presented above, but that it can be implemented in other embodiments using equivalent means without deviating from the characteristics of the invention. A number of features were described as part of examples in the foregoing and wherever technically possible, the features should be regarded as optional and combinable with any different other examples of the description. For instance, the invention is useful also in various electronic devices, particularly in portable electronic books, PDA devices, gaming devices, music players, DRM enabled set-top boxes capable of providing limited access to (rented) content and GPS positioning devices. Hence, the scope of the invention is only restricted by the attached patent claims.

1. A security circuitry for storing information into a protected memory circuitry that is capable of reliably saving data for an estimated number of times, the security circuitry comprising:
a processor capable of negotiating with the protected memory circuitry an access to the protected memory circuitry and capable of producing state information desirable to maintain over power break-ups;
wherein the processor is configured to output information to the protected memory circuitry using the access probabilistically so as to guard the protected memory circuitry for securing reliable storing of information by the protected memory circuitry substantially as long as targeted.

2. A security circuitry according to claim 1, wherein the processor is capable of performing a plurality of security related operations and configured to verify a subsequent security related operation using a previously stored state information so that when a predetermined criterion is met, the processor uses the state information from the protected memory circuitry and when the predetermined criterion is not met, the processor uses the state information retrieved from a secondary memory.

3. A security circuitry according to claim 2, wherein the secondary memory is selected from a group consisting of: a volatile memory of the security circuitry, an external volatile memory and an external persistent memory.

4. A security circuitry according to claim 1, wherein the protected memory circuitry comprises a disposable portion for performing dummy state information storage and a use portion for substantially reliably saving the state information, whereby the processor is further configured to indicate to the protected memory circuitry the portion into which information should be stored.

5. A security circuitry according to claim 1, configured to attempt saving the state information to the disposable memory together with an error detection code for subsequent reading with the processor and if the error detection code does not indicate errors, to use the read state information.

6. A security circuitry according to claim 5, wherein the security circuitry is configured to save the state information to the disposable portion as long as no errors are indicated and only after the disposable portion no longer reliably stores information to send the state information to the use portion.

7. A security circuitry according to claim 5, wherein the processor is configured to read the protected memory circuitry contents and to determine based upon the read information if the protected memory circuitry contains bad parts and to avoid outputting data to determined bad parts.

8. A security circuitry according to claim 5, having access to a non-volatile memory that stores authentication information for authenticating the security circuitry to a protected memory circuitry and further configured to use the authentication information for the encrypted access to the protected memory circuitry.

9. A security circuitry according to claim 1, wherein the security circuitry is a base-band Application Specific Integrated Circuit (ASIC).

10. An assembly module comprising a security circuitry for storing information into a protected memory circuitry that is capable of reliably saving data for an estimated number of times, the security circuitry comprising:
a processor capable of negotiating with the protected memory circuitry an access to the protected memory circuitry and capable of producing state information desirable to maintain over power break-ups;
wherein the processor is configured to output information to the protected memory circuitry using the access probabilistically so as to guard the protected memory circuitry for securing reliable storing of information by the protected memory circuitry substantially as long as targeted.

11. An assembly module according to claim 10, wherein the protected memory circuitry further comprises a persistent memory and a communication logics configured to control access to the persistent memory.

12. An assembly module according to claim 10, wherein the protected memory circuitry comprises an analogue integrated circuit comprising a flash memory.

13. An assembly module according to claim 10, wherein the protected memory circuitry is built into an energy management circuitry.

14. A protected memory circuitry for providing probabilistic data storage for a processor, comprising:
an analogue rewriteable persistent memory with at least two individually writeable portions including a use portion and a disposable portion;
a communication logics capable of cryptographically protected communications with the processor, configured to receive cryptographically secured information and commands from the processor and accordingly to store information into the use portion or to simulate storing into the use portion by storing information into the disposable portion.

15. A protected memory circuitry according to claim 14, cryptographically initialised to enable the cryptographically protected communications with the processor.

16. A protected memory circuitry according to claim 14, wherein the protected memory circuitry is manufactured onto an energy management circuitry.

17. A computer program for controlling a processor to perform probabilistic saving of data, the computer program comprising:
computer executable program code for causing the processor to communicate with a protected memory circuitry capable of reliably saving data for an estimated number of times;
computer executable program code for causing the processor to negotiate with the protected memory circuitry an access to the protected memory circuitry;
computer executable program code for causing the processor to produce state information desirable to maintain over power break-ups;
computer executable program code for causing the processor to output information to the protected memory circuitry using the access probabilistically so as to guard the protected memory circuitry for securing reliable storing of information by the protected memory circuitry substantially as long as targeted.

18. A computer program for controlling a communication logics of a protected memory circuitry further comprising a persistent memory capable of reliably saving data for an estimated number of times for providing a processor a substantially secure persistent storage, the computer program comprising:
computer executable program code for causing the communication logics to communicate with the processor;
computer executable program code for causing the communication logics to receive cryptographically secured information and commands from the processor and accordingly to store information into the use portion or to simulate storing into the use portion by storing information into the disposable portion.
